(19) United States
(12) Patent Application Publication
(10) Pub. No.: US 2010/0302703 A1
(43) Pub. Date: Dec. 2, 2010

(54) THIN FILM CAPACITORS WITH MAGNETICALLY ENHANCED CAPACITANCE

(75) Inventor: Wein-Kuen HWANG, HSINCHU (TW)

Correspondence Address: BRIAN M. MCINNIS, 12th Floor, Ruttonjee House, 11 Duddell Street, Hong Kong, HK

(73) Assignee: RITEK CORPORATION, HSINCHU (TW)

(21) Appl. No.: 12/508,565

(22) Filed: Jul. 24, 2009

Related U.S. Application Data
(63) Continuation-in-part of application No. 12/472,654, filed on May 27, 2009, now abandoned.

(51) Int. Cl. H01G 4/008

(52) U.S. Cl. 361/305

(57) ABSTRACT

A capacitor is disclosed. The capacitor includes a conductive and non-magnetic layer, a magnetic and conductive layer, and a dielectric layer. The dielectric layer is disposed between the conductive and non-magnetic layer and the magnetic and conductive layer. The magnetic and conductive layer is capable of generating a magnetic field, and thus enhances the dielectric constant of the dielectric layer for at least 10 folds.

### RELATED APPLICATION

This is a continuation-in-part of application Ser. No. 12/472,654, filed May 27, 2009, now abandoned.

### BACKGROUND

1. Field of Invention

The present invention relates generally to the field of capacitors. More particularly, the present invention relates to magnetically enhanced capacitors.

2. Description of Related Art

Capacitors provide a reliable source of power in many applications, such as integrated circuits (IC), printed circuit boards (PCB), and other electronic devices. Capacitors can be fabricated in various shapes and size and provide comparable characteristics to other common power supply devices.

Generally, capacitors essentially consist of two parallel plates and a dielectric material disposed therebetween, as shown in FIG. 1. The capacitor 100 includes two conducting parallel plates 110, 120) and a dielectric material 130. In general, the thickness d of the dielectric material 130 equals the distance between the two conducting plates. The capacitance C of the capacitor 100 can be expressed by equation (1).

C=e₀eᵣA/d (1)

where e₀ is the dielectric constant of free space (8.85×10⁻¹⁴F/cm), and eᵣ is the relative dielectric constant of the dielectric material disposed between the conducting plates. The product of e₀ and eᵣ is defined as permittivity e, which represents the absolute permittivity of the dielectric material.

According to equation (1), the capacitance of a capacitor increases as the thickness d of the dielectric material decreases. However, the breakdown voltage of the capacitor decreases significantly as the thickness of the dielectric material decreases. Moreover, as the thickness of the dielectric material is reduced to less than about 10 nm, it presents serious challenges to the manufacturing processes. Therefore, researchers consider the thickness of the dielectric material as a trade-off among capacitance, breakdown voltage, and productivity.

Another factor that affects the capacitance of a capacitor is the dielectric constant (K) of the dielectric material. The dielectric constant (K) of a material is the ratio of the permittivity over the dielectric constant of free space. A higher K-value implies that more electrical charge/energy could be stored in the capacitors, and a smaller size of the electronic devices can be implemented. Unfortunately, the K-value of conventional dielectric materials, such as mica, glass, plastics, and metal oxides only ranges from 2 to 10 approximately.

Recently, some perovskite-oxides with high K-value have been reported. For instance, the ferroelectric and paraelectric dielectric materials with perovskite-oxide structure have a K-value of about 10³-10⁴. While the dielectric material having a K-value of about 10⁴ and a thickness of about 100 nm is adopted for constructing a capacitor, the corresponding capacitance is about 10⁻⁴ F/cm ². Some perovskite metal oxides, such as barium strontium titanate (BST) family, lead zirconium titanate (PZT) family, calcium copper titanate (CCTO) family, exhibit a satisfactory K-value of about 10³ to 10⁶ (See U.S. Pat. No. 7,428,137 and US Patent Publication No. 2008/0218940). As the K-value and thickness of the dielectric material are respectively about 10⁶ and 100 nm, the corresponding capacitance is in the range of 10⁻²-10⁻³ F/cm², and the breakdown voltage is approximately in the range of 10-100 V. It is desirable to implement high-K materials into capacitors for applications in high-energy storage, memory devices (such as MRAM) having high-capacity data storage, or others. Capacitance in the range of 10⁻² to 10⁻³ F/cm² is not enough for high-energy storage applications.

The dielectric constant (K) of La₁₋ₓSrₓMnO₃ is enhanced for about 10² to 10³ folds under an external magnetic filed of 20 KOe (JEPT Letter (2007), 86(10): 643-646). However, it is impracticable to provide a magnetic field of 20 KOe for capacitors in electronic devices. An apparatus that is capable of generating a magnetic field of over 20 KOe would weigh about 100 Kg. Therefore, there exists in this art a need of a probable way to achieve an effective K value that is greater than 10⁶.

### SUMMARY

The present invention provides a capacitor, which comprises a non-magnetic layer; a magnetic layer capable of generating a magnetic field; and a dielectric layer disposed between the non-magnetic layer and the magnetic layer; wherein both the non-magnetic layer and the magnetic layer are conductive layers and the dielectric constant of the dielectric layer is enhanced by the magnetic field generated by the magnetic layer for at least about 10 folds.

According to one embodiment of the present invention, the magnetic layer has a thickness from 20-1000 nm and has a magnetization from 100-2,500 emu/cm³. The magnetization of the magnetic layer has a vector component that is parallel with the magnetic layer, and comprises a vector component normal to the magnetic layer. In one example, the magnetic layer is made of a material having a formula of Ndₓ(Fe_{y}Co_{1-y})₁₋ₓ, wherein x is a number from about 0.10 to about 0.35, and y is a number from 0 to 1. In another example, the magnetic layer Is made of a material having a formula of Tbₘ(Fe_{y}Co_{1-y})₁₋ₘ, wherein m is a number from about 0.10 to 0.22 and from about 0.25 to about 0.35, and y is a number from 0 to 1. In still another example, the magnetic layer is made of a material having a formula of Niₙ(Fe_{y}Co_{1-y})₁₋ₙ, wherein n is a number from 0 to 1, and y is a number from 0 to 1.

According to one embodiment of the present invention, the enhanced dielectric constant of the dielectric layer is in the range of 10⁷ to 10⁹.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic cross-sectional view of a traditional capacitor in the prior art; and

FIG. 2 is a schematic cross-sectional view of the capacitor according to one embodiment of the present invention.

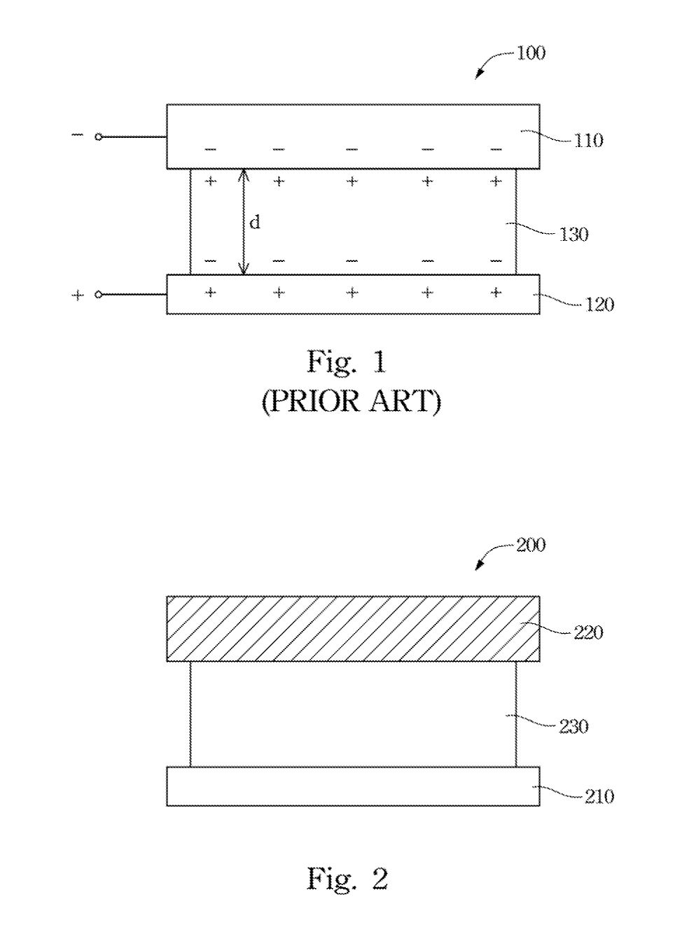

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

Referring to FIG. 2, which is a schematic cross-sectional view of a capacitor 200 according to one embodiment of the present invention. The capacitor 200 includes a non-magnetic layer 210, a magnetic layer 220, and a dielectric layer 230, in which both the non-magnetic layer 210 and the magnetic layer 220 are conductive layers. The dielectric layer 230 is disposed between the non-magnetic layer 210 and the magnetic layer 220. In one embodiment, the thickness of the dielectric layer 230 is the distance between the non-magnetic layer 210 and the magnetic layer 220.

The non-magnetic layer 210 is made from an electrically conductive metal or alloy, but without magnetism, which includes, but is not limited to, Ag, Pd, Au, La, Cu or the combination thereof. In one examples the non-magnetic layer 210 is made of aluminum (Al). In another example, the non-magnetic layer 210 is a platinum (Pt) layer. In general any non-magnetic metal or alloy can be used as the non-magnetic layer 210 in the present invention.

The non-magnetic layer 210 may be formed by any known method, which includes, but is not limited to, sputtering, e-beam evaporation, ion-beam deposition or pulsed laser deposition. For example, the non-magnetic layer 210 can be deposited on an appropriate substrate such as glass or ceramic using a metal target in an argon environment by sputtering.

There is no specific limitation on the thickness of the non-magnetic layer 210, but typically it can be in the range of about twenty to several hundred nanometers. In one example, the thickness of the non-magnetic layer 210 is about 20-100 nm.

The dielectric layer 230 is disposed on the non-magnetic layer 210. In order to achieve a high capacitance of the capacitor 200, the dielectric layer 230 preferably has a high-K value (i.e. high dielectric constant). The dielectric layer 230 can be a material of multiferroics that is known in the art. The term “multiferroics” herein represents materials that primarily exhibit ferromagnetic, ferroelectric, and ferroelastic properties. Typical multiferroics belong to the group of perovskite-structure metal oxides with or without dopants. In particular, the dielectric layer 230 comprises a perovskite-structure metal oxide such as barium strontium titanate (BST), barium titanate (BTO), lead zirconium titanate (PZT), or calcium copper titanate (CCTO). For example, a layer of CCTO can be deposited using a prepared target and suitable mask by pulsed laser deposition or by sputtering. It is to be noted that other conventional dielectric materials may also be used in the present invention.

There is no specific limitation on the thickness of the dielectric layer 220, but typically it can be in the range of about twenty to several hundred nanometers. In one example, the thickness of the dielectric layer 220 is about 20-100 nm.

The magnetic layer 220 is disposed on the dielectric layer 230, and therefore the dielectric layer 230 is sandwiched between the non-magnetic layer 210 and the magnetic layer 220. The magnetic layer 220 is capable of generating a magnetic field and is electrically conductive. In one example, the magnetic layer 220 is made of a ferromagnetic material or a ferrimagnetic material. Suitable materials for making the magnetic layer 220 include, but are not limited to, (Ni,Fe,Co) family, CoCr(Pt,Ta,Ni,B,Si,O,SiO₂) family, (Pr,Nd,Pm,Sm,Eu,Gd,Tb,Dy,Ho,Er)(Ni,Fe,Co)(Cr,N,Ta,Ti,O,Al,B,Mo) family, (Ni,Fe,Co,Ir,Pt)Mn family, Nd(Ni,Fe,Co)B family, (Ba,Ni,Fe,Co,Mn,Zn,Y,Mg,Zn,Cd)-oxide family, (Pr,Nd,Pm,Sm,Eu,Gd,Tb,Dy,Ho,Er,Al,Ni,Pt,Pd,Si)Co family, and (Pr,Nd,Pm,Sm,Eu,Gd,Tb,Dy,Ho,Er,Al,Ni,Pt,Pd,Si)Fe family.

The magnetic layer 220 can be formed on the dielectric layer 230 by well known techniques such as sputtering thermo-evaporation, ion-beam assisted evaporation, e-beam evaporation, ion-beam deposition, pulsed laser deposition, or other technologies suitable for forming the magnetic layer 220. For instance, magnetic layer 220 can be deposited on the dielectric layer using suitable targets in an argon environment by sputtering.

After the magnetic layer 220 is formed on the dielectric layer 230, magnetic initialization is conducted to initialize the magnetization of the magnetic layer 220. By applying an external magnetic filed to the magnetic layer 220, the magnetization orientation of the magnetic layer 220 is aligned in one specific direction. Preferably, the specific direction is chosen to have a strong magnetic coupling with the electric dipoles of the dielectric layer 230 to obtain a better capacitance. The better orientation of the magnetization of the magnetic layer 220 depends on the properties of the dielectric layer 230. In general, a better orientation of the magnetization for a specific dielectric material can be estimated by experiments. It is to be noted that the present invention is not limited to any specific orientation of the magnetization.

In one example, the magnetization of the magnetic layer 220 can has a direction that is parallel with or orthogonal to the magnetic layer 220. In another example, the magnetization of the magnetic layer 220 comprises both of a vector component normal to the magnetic layer 220 and a vector component parallel with the magnetic layer 220. That is, the direction of the magnetization forms an angle between 0 and 90 degree with the plane of the magnetic layer 220.

In some embodiments, the magnetic layer has a thickness from about 20 nm to about 1000 nm and has a magnetization from about 100 to about 2,500 emu/cm³.

In one embodiment, the magnetic layer 220 is made of an alloy having a formula of Ndₓ(Fe_{y}CO_{1-y})₁₋ₓby sputtering, wherein x is a number from about 0.10 to about 0.35, and y is a number from 0 to 1. That is, the magnetic layer 220 contains about 10-35 atom % of Nd, and about 65-90 atom % of the iron and cobalt. The sputtering process of the magnetic layer 220 utilizes one Fe/Co target and one Nd target simultaneously. As y is equal to 0, that means a pure Co target and a pure Nd target are used in the sputtering process. As y equals 1 that means a pure Fe target and a pure Nd target are used in the sputtering. The y value is controlled by the composition of the Fe/Co target, and the x value is controlled by the process parameters. In one embodiment, the magnetic layer 220 has a magnetization of about 800-2500 emu/cm³ and the dielectric constant of the dielectric layer 230 can be increased up to about 10⁷-10⁹.

Alternatively, the magnetic layer 220 has a supper lattice structure having a formula of Ndₓ(Fe_{y}Co_{1-y})₁₋ₓ, wherein x is a number from about 0.05 to about 0.40, and y is a number from 0 to 1, and have a total thickness of from 10 nm to 100 nm.

In one embodiment, the magnetic layer 220 is made of an alloy having a formula of Tbₘ(Fe_{y}Co_{1-y})₁₋ₘ by sputtering, wherein m is a number from about 0.10 to about 0.22 and from about 0.25 to about 0.35, and y is a number from 0 to 1. As y is equal to 0, that means a pure Co target and a pure Tb target are used in the sputtering process. As y equals 1, that means a pure Fe target and a pure Tb target are used in the sputtering. The y value is controlled by the composition of the Fe/Co target, and the x value is controlled by the process parameters. In one embodiment, the magnetic layer 220 has a magnetization of about 60-600 emu/cm³ and the dielectric constant of the dielectric layer 230 can be increased up to about 10⁷∫10⁹.

Alternatively, the magnetic layer 220 could be a supper lattice structure having a formula of Tbₘ(Fe_{y}Co_{1-y})₁₋ₘ, wherein m is a number from about 0.05 to 0.22 and from about 0.25 to about 0.40, and y is a number from 0 to 1, and have a total thickness of from 10 nm to 100 nm.

In another embodiment, the magnetic layer 220 is made of a material having a formula of Niₙ(Fe_{y}Co_{1-y})₁₋ₙ by sputtering, wherein y is a number from 0 to 1, and n is a number from 0 to 1. As y is equal to 0, that means a pure Co target and a pure Ni target are used in the sputtering. As y equals 1, that means a pure Fe target and a pure Ni target are used in the sputtering. As n is equal to 0, that means only a Fe/Co target Is used in the sputtering. As n equals 1, that means only a pure Ni target is used in this embodiment. In one embodiment, the magnetic layer 220 has a magnetization of about 600-2000 emu/cm³ and the dielectric constant of the dielectric layer 230 can be increased up to about 10⁷-10⁹.

Alternatively, the magnetic layer 220 could be a supper lattice structure having a formula of Niₙ(Fe_{y}Co_{1-y})₁₋ₙ, wherein n is a number from 0 to 0.999, and y is a number from 0 to 1, and have a total thickness of from 10 nm to 100 nm.

While the magnetic layer 220 has a magnetization of 2,000 emu/cm³, a magnetic field of about 20 KOe can be further provided to interact with the dielectric material near the interface between the magnetic layer 220 and the dielectric layer 230. The magnetic field can induce more electric dipoles in the dielectric layer 230 near the interface between the magnetic layer 220 and the dielectric layer 230. As a result, the effective K-value of the dielectric layer 230 is enhanced at least 10 folds, for example, 10²-10³ folds, as compared to the conventional capacitor without magnetic layer. In a specific embodiment, the enhanced dielectric constant is increased to the range of 10⁷ to 10⁹. Furthermore, the required magnetic layer 220 can easily be formed by appropriate thin film process. The capacitors can be manufactured to be very compact in size, and therefore achieving a higher energy density.

### EXAMPLES

The following Examples are provided to illustrate certain aspects of the present invention and to aid those of skill in the ad in practicing this invention. These Examples are in no way to be considered to limit the scope of the invention in any manner.

### Example 1

### Generating a Magnetic Field Parallel With the Magnetic Layer

A layer of aluminum (Al) about 100 nm in thickness was deposited on a ceramic substrate using an Al target in an argon (Ar) environment by sputtering. During the Al sputtering process, a DC source of 3 Kw was used and the Ar flow rate was 30 sccm. Next, a 50 nm layer of CaCu₃Ti₄O₁₂ (CCTO) was deposited on the Al layer using a CCTO target in an argon (Ar) environment by sputtering. During the CCTO sputtering process) a RF source of 1 Kw was used and the Ar flow rate was also 30 sccm. And then, a layer of Nd—Fe—Co alloy about 50 nm in thickness was deposited on the CCTO layer in an argon (Ar) environment by sputtering.

In this embodiment, the sputtering process of the Nd—Fe—Co layer utilizes one Fe/Co target and one pure Nd target simultaneously. The Fe/Co target contains 80 atom % of iron and 20 atom % of cobalt. Thus, an Nd—Fe—Co layer having a formula of Nd_{0.25}(Feo_{0.80}Co_{0.20})_{0.75} is obtained by controlling the process parameters such as power supplies.

After the Nd—Fe—Co layer was formed, an external magnetic field parallel with the Nd—Fe—Co layer was applied to initialize the magnetization of the magnetic layer. The applied magnetic field was larger than 500 Oe to overcome the coercivity of the Nd—Fe—Co layer. After removing the external magnetic field, the magnetization of the Nd—Fe—Co layer keeps in parallel with the layer surface, and generates a magnetic filed in parallel with the Nd—Fe—Co layer. In this example, the ND—Fe—Co layer had a magnetization of about 2000 emu/cm³ and the dielectric constant of the dielectric layer (CCTO) was increased up to about 10⁹.

### Example 2

### Generating a Magnetic Field Orthogonal to the Magnetic Layer

The non-magnetic layer was prepared in accordance with the procedures described in Example 1. A 50 nm layer of barium titanate (BTO) was deposited on the Al layer using a BTO target in an argon (Ar) environment by sputtering. Next, a Tb—Fe—Co layer was deposited on the BTO layer in an argon environment by a sputtering process that is similar to Example 1. The Tb—Fe—Co layer had a thickness of 50 nm with a formula of Tb_{0.21} (Fe_{0.80}Co_{0.20})_{0.79}.

After the Tb—Fe—Co layer was formed, an external magnetic field orthogonal to the Tb—Fe—Co layer was applied to initialize the magnetization of the magnetic layer. The applied magnetic field was larger than 10,000 Oe to overcome the coercivity of the Tb—Fe—Co layer. After removing the external magnetic field, the magnetization of the Tb—Fe—Co layer is perpendicular to the layer surface and generates a magnetic filed orthogonal to the Tb—Fe—Co layer. In this example, the Tb—Fe—Co layer had a magnetization of about 200 emu/cm³ and the dielectric constant of the dielectric layer (BTO) was increased up to about 10⁷.

### Example 3

### Generating a Magnetic Field at an Angle to the Magnetic Layer

The non-magnetic layer and the dielectric layer were prepared in accordance with the procedures described in Example 1. A 50 nm layer of Ni—Fe—Co alloy with a formula of Ni_{0.20}(Fe_{0.80}Co_{0.20})_{0.80} was deposited on the CCTO layer in an argon environment by sputtering. In this embodiment, the sputtering process of the Ni—Fe—Co layer utilizes one Fe/Co target and one Ni target simultaneously.

After the Ni—Fe—Co layer was formed, an external magnetic field was applied to initialize the magnetization of the magnetic layer. The applied magnetic field was larger than 500 Oe and in a direction at an angle of 45 degree to the plane of the Ni—Fe—Co layer. After removing the external magnetic field, the Ni—Fe—Co layer had a magnetization of about 1500 emu/cm³ and the enhanced dielectric constant of the dielectric layer was increased up to about 10⁹.

It will be apparent to those skilled in the art that various modifications and variations can be made to the structure of the present invention without departing from the scope or spirit of the invention. In view of the foregoing, it is intended that the present invention cover modifications and vacations of this invention provided they fall within the scope of the following claims.

What is claimed is:

1. A capacitors comprising:
a nonmagnetic layer,
a magnetic layer capable of generating a magnetic field; and
a dielectric layer disposed between the non-magnetic layer and the magnetic layer;
wherein both the non-magnetic layer and the magnetic layer are conductive layers and the dielectric constant of the dielectric layer is enhanced by the magnetic field generated by the magnetic layer for at least about 10 folds.

2. The capacitor according to claim 1, wherein the magnetic layer is made of a ferromagnetic material or a ferrimagnetic material.

3. The capacitor according to claim 1, wherein the magnetic layer has a magnetization of larger than about 100 emu/cm³.

4. The capacitor according to claim 3, wherein the magnetization has a direction that is parallel with the magnetic layer.

5. The capacitor according to claim 3, wherein the magnetization has a direction that is orthogonal to the magnetic layer.

6. The capacitor according to claim 3, wherein the magnetization comprises a vector component normal to the magnetic layer and a vector component parallel to the magnetic layer.

7. The capacitor according to claim 1, wherein the magnetic layer is made of an alloy having a formula of Ndₓ(Fe_{y}Co_{1-y})₁₋ₓ, wherein x is a number from about 0.10 to about 0.35, and y is a number from 0 to 1.

8. The capacitor according to claim 1, wherein the magnetic layer is made of an alloy having a formula of Tbₘ(Fe_{y}Co_{1-y})₁₋ₘ, wherein m is a number from about 0.10 to about 0.22 and from about 0.25 to about 0.35, and y is a number from 0 to 1.

9. The capacitor according to claim 1, wherein the magnetic layer is made of a material having a formula of Niₙ(Fe_{y}Co_{1-y})₁₋ₙ, wherein n is a number from 0 to 1, and y is a number from 0 to 1.

10. The capacitor according to claim 1, wherein the magnetic layer has a supper lattice structure with a thickness of about 10 nm to about 100 nm.

11. The capacitor according to claim 10, wherein the supper lattice structure has a formula of Ndₓ(Fe_{y}Co_{1-y})₁₋ₓ, wherein x is a number from about 0.05 to about 0.40, and y is a number from 0 to 1.

12. The capacitor according to claim 10, wherein the supper lattice structure has a formula of Tbₘ(Fe_{y}Co_{1-y})₁₋ₘ, wherein m is a number from about 0.05 to about 0.22 and from about 0.25 to about 0.40, and y is a number from 0 to 1.

13. The capacitor according to claim 10, wherein the supper lattice structure has a formula of Niₙ(Fe_{y}Co_{1-y})₁₋ₙ, wherein n is a number from 0 to 0.999 and y is a number from 0 to 1.

14. The capacitor according to claim 1, wherein the dielectric layer comprises a material of multiferroics.

15. The capacitor according to claim 1, wherein the dielectric layer comprises a perovskite-structure metal oxide.

16. The capacitor according to claim 15, wherein the perovskite-structure metal oxide is barium strontium titanate, barium titanate, lead zirconium titanate, or calcium copper titanate.

17. The capacitor according to claim 1 wherein the non-magnetic layer comprises at least one metal selected from the group consisting of Ag, Cu, Pt, Pd, Au, La, and Al.

18. The capacitor according to claim 1, wherein the enhanced dielectric constant is in the range of 10⁷ to 10⁹.

19. The capacitor according to claim 1, wherein the magnetic layer has a magnetization of larger than about 1,000 emu/cm³.

20. The capacitor according to claim 1, wherein the magnetic layer has a thickness of about 20 nm to about 1000 nm.
